(19) United States
(12) Patent Application Publication
(10) Pub. No.: US 2013/0099791 A1
(43) Pub. Date: Apr. 25, 2013

(54) Methodologies to Improve Reliability of Transducer Electrical Interconnections

(71) Applicants: Laam Angela Tse, Sugar Land, TX (US); Roger R. Steinsiek, Houston, TX (US); Douglas J. Patterson, Spring, TX (US)

(72) Inventors: Laam Angela Tse, Sugar Land, TX (US); Roger R. Steinsiek, Houston, TX (US); Douglas J. Patterson, Spring, TX (US)

(73) Assignee: Baker Hughes Incorporated, Houston, TX (US)

(21) Appl. No.: 13/279,840

(22) Filed: Oct. 24, 2011

(51) Int. Cl. G01V 3/00

(52) U.S. Cl. 324/347

(57) ABSTRACT

The present disclosure relates to methods and apparatuses measuring a property of a material. The apparatus may include a transducer comprising a first electrical conductor, a second electrical conductor, and a piezoelectric component configured to receive the two conductors. The piezoelectric component may include a cavity dimensioned to improve the strength of or reduce stress on an interconnection between piezoelectric component and at least one of the conductors. The method may include using one or more transducers measuring a property of a material. In some embodiments, the material may be an earth formation.

### BACKGROUND OF THE DISCLOSURE

1. Field of the Disclosure

This disclosure generally relates to exploration and production of hydrocarbons involving investigations of regions of an earth formation penetrated by a borehole. More specifically, the disclosure relates to reducing stress on and/or increasing strength of an interconnection between electrical conductors and a piezoelectric component in an acoustic transducer used for acoustic logging operations in the borehole.

2. Description of the Related Art

The exploration for and production of hydrocarbons may involve a variety of techniques for characterizing earth formations. Acoustic logging tools for measuring properties of the sidewall material of both cased and uncased boreholes are well known. Essentially such tools measure the travel time of an acoustic pulse propagating through the sidewall material over a known distance. In some studies, the amplitude and frequency of the acoustic pulse, after passage through the earth, are of interest.

In its simplest form, an acoustic logger may include one or more transmitter transducers that periodically emit an acoustic signal into the formation around the borehole. One or more acoustic sensors, spaced apart by a known distance from the transmitter, may receive the signal after passage through the surrounding formation. The difference in time between signal transmission and signal reception divided into the distance between the transducers is the formation velocity. If the transducers do not contact the borehole sidewall, allowance must be made for time delays through the borehole fluid.

Materials with piezoelectric properties are commonly used in acoustic transducers, which may act as transmitters and/or acoustic sensors. In a downhole environment, stresses (thermal, mechanical, etc.) may compromise the physical connection between the piezoelectric material and electrical wires. Commonly, acoustic transducers include wires that are soldered or bonded directly to the flat electrode surfaces of the piezoelectric material during the electrical assembly processes. This type of bonding method provides limited bonding surfaces and without any good strain relief to the wires, thus the interconnections of wires and the piezoelectric material are weak and not reliable especially during the extreme vibration and shock conditions of tool transportation or downhole logging processes. The present disclosure addresses this reliability problem.

### SUMMARY OF THE DISCLOSURE

In view of the foregoing, the present disclosure is directed to a method and apparatus for estimating at least one parameter of interest of an earth formation using one an acoustic tool configured to reduce at least one high-order mode of an acoustic pulse from a monopole acoustic source in a borehole.

One embodiment of the according to the present disclosure includes a method of measuring a property of a material, comprising: measuring the property of the material using a transducer, the transducer comprising: a first electrical conductor, a second electrical conductor, and a piezoelectric component configured to receive the first electrical conductor in a first cavity and the second electrical conductor in a second cavity.

Another embodiment according to the present disclosure includes an apparatus for measuring a property of a material, comprising: a first electrical conductor; a second electrical conductor; and a piezoelectric component configured to receive the first electrical conductor in a first cavity and the second electrical conductor in a second cavity.

### BRIEF DESCRIPTION OF THE DRAWINGS

The present disclosure is best understood with reference to the accompanying figures in which like numerals refer to like elements and in which like numerals refer to like elements and in which:

FIG. 1 is a schematic of a drilling site including an acoustic tool for estimating at least one parameter of interest of an earth formation according to one embodiment of the present disclosure;

FIG. 2 is a schematic of an acoustic tool according to one embodiment of the present disclosure;

FIG. 3A is a top view of an acoustic transducer according to one embodiment of the present disclosure;

FIG. 3B is a side view of an acoustic transducer according to one embodiment of the present disclosure;

FIG. 3C is a bottom view of an acoustic transducer according to one embodiment of the present disclosure;

FIG. 3D is another side view of an acoustic transducer according to one embodiment of the present disclosure;

FIG. 3E is a right side view of an acoustic transducer according to one embodiment of the present disclosure;

FIG. 4A is a top view of an acoustic transducer according to another embodiment of the present disclosure;

FIG. 4B is a side view of an acoustic transducer according to another embodiment of the present disclosure;

FIG. 4C is a bottom view of an acoustic transducer according to another embodiment of the present disclosure;

FIG. 4D is another side view of an acoustic transducer according to another embodiment of the present disclosure; and

FIG. 5 is a flow chart of a method according to one embodiment of the present disclosure.

### DETAILED DESCRIPTION OF THE DISCLOSURE

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering and programming practices for the environment in question. It will be appreciated that such development efforts may be complex and time-consuming, outside the knowledge base of typical laymen, but would nevertheless be a routine undertaking for those of ordinary skill in the relevant fields.

Reliable acoustic transducer connections are highly desirable, particularly in environments where a malfunction or breakdown in an acoustic tool may result in significant losses of money and time. Acoustic transducers may be constructed with electrical connections to piezoelectric materials, such as, but not limited to, piezoceramics. Electrical wires may be bonded directly to the flat piezoceramic surfaces.

Failure of these electrical connections may be reduced by providing extra strain relief for the electrical connections and/or increasing the bonding strength of the electrical connections. Ultimately, the improved transducer interconnections may allow downhole acoustic imagers to be more reliable and have better logging performance.

In the present disclosure, acoustic borehole logging may be performed using acoustic transducers with interconnections developed for making electrical contacts to piezoceramics. One type of interconnection may include producing shallow grooves onto the surfaces of the piezoceramic prior to an electrode coating process. The grooves may provide extra bonding surfaces for wires to be soldered or bonded to the piezoceramics. The grooves may also provide recessed interconnections with extra bonding surfaces for better fitting of acoustic windows over the piezoceramics for transducer performance enhancement.

Another type of interconnection may include at least two channels (or vias) through the thickness of the electrodes on the piezoceramics that are formed prior to coating the conductive electrode layers. The channels may be coated with the conductive material to provide continuous electrical paths through the channels to the opposite side of the electrodes. Instead of bonding the electrical wires directly to the flat electrode surfaces, wires may be fed through the channels and bonded to the opposite surfaces of the electrode to provide extra strain relief to the interconnections. The extra strain relief may reduce the likelihood of interconnection failure. The channels may be located on the same side or opposite sides of the piezoceramic. Illustrative embodiments of the present claimed subject matter are described in detail below.

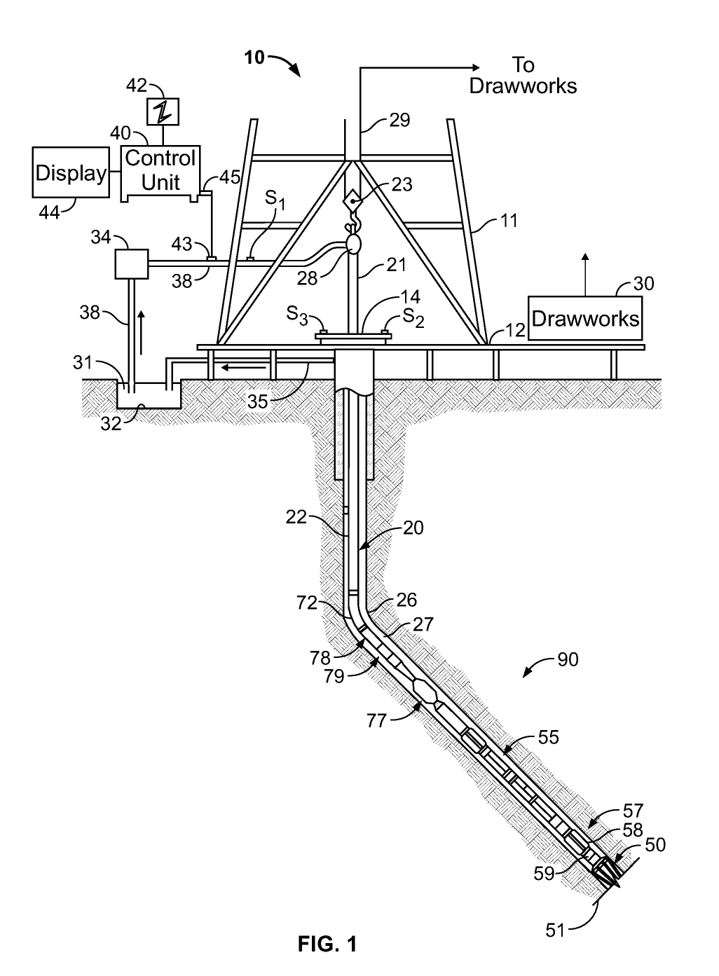

FIG. 1 shows a schematic diagram of a drilling system 10 with a drillstring 20 carrying a drilling assembly 90 (also referred to as the bottomhole assembly, or “BHA”) conveyed in a “wellbore” or “borehole” 26 for drilling the borehole. The drilling system 10 includes a conventional derrick 11 erected on a floor 12 which supports a rotary table 14 that is rotated by a prime mover such as an electric motor (not shown) at a desired rotational speed. The drillstring 20 includes tubing such as a drill pipe 22 or a coiled-tubing extending downward from the surface into the borehole 26. The drillstring 20 is pushed into the borehole 26 when a drill pipe 22 is used as the tubing. For coiled-tubing applications, a tubing injector (not shown), however, is used to move the tubing from a source thereof, such as a reel (not shown), to the borehole 26. The drill bit 50 attached to the end of the drillstring breaks up the geological formations when it is rotated to drill the borehole 26. If a drill pipe 22 is used, the drillstring 20 is coupled to a drawworks 30 via a kelly joint 21, swivel 28, and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger (not shown), fluid line 38 and kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ placed in the line 38 can provide information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the disclosure, the drill bit 50 is rotated by only rotating the drill pipe 22. In another embodiment of the disclosure, a downhole motor 55 (mud motor) is disposed in the drilling assembly 90 to rotate the drill bit 50 and the drill pipe 22 is rotated usually to supplement the rotational power, if required, and to effect changes in the drilling direction.

In one embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly.

In one embodiment of the disclosure, a drilling sensor module 59 is placed near the drill bit 50. The drilling sensor module may contain sensors, circuitry, and processing software and algorithms relating to the dynamic drilling parameters. Such parameters can include bit bounce, stick-slip of the drilling assembly, backward rotation, torque, shocks, borehole and annulus pressure, acceleration measurements, and other measurements of the drill bit condition. A suitable telemetry or communication sub 77 using, for example, two-way telemetry, is also provided as illustrated in the drilling assembly 90. The drilling sensor module processes the sensor information and transmits it to the surface control unit 40 via the telemetry system 77.

The communication sub 77, a power unit 78 and an MWD tool 79 are all connected in tandem with the drillstring 20. Flex subs, for example, are used in connecting the MWD tool 79 in the drilling assembly 90. Such subs and tools may form the bottom hole drilling assembly 90 between the drillstring 20 and the drill bit 50. The drilling assembly 90 may make various measurements including pulsed nuclear magnetic resonance measurements while the borehole 26 is being drilled. The communication sub 77 obtains the signals and measurements and transfers the signals, using two-way telemetry, for example, to be processed on the surface. Alternatively, the signals can be processed using a downhole processor at a suitable location (not shown) in the drilling assembly 90.

The surface control unit or processor 40 may also receive one or more signals from other downhole sensors and devices and signals from sensors S1-S3 and other sensors used in the system 10 and processes such signals according to programmed instructions provided to the surface control unit 40. The surface control unit 40 may display desired drilling parameters and other information on a display/monitor 44 utilized by an operator to control the drilling operations. The surface control unit 40 can include a computer or a microprocessor-based processing system, memory for storing programs or models and data, a recorder for recording data, and other peripherals. The control unit 40 can be adapted to activate alarms 42 when certain unsafe or undesirable operating conditions occur.

While a drill string 20 is shown as a conveyance system for BHA 90, it should be understood that embodiments of the present disclosure may be used in connection with tools conveyed via rigid (e.g. jointed tubular or coiled tubing) as well as non-rigid (e.g. wireline, slickline, e-line, etc.) conveyance systems. A downhole assembly (not shown) may include a bottomhole assembly and/or sensors and equipment for implementation of embodiments of the present disclosure on either a drill string or a wireline.

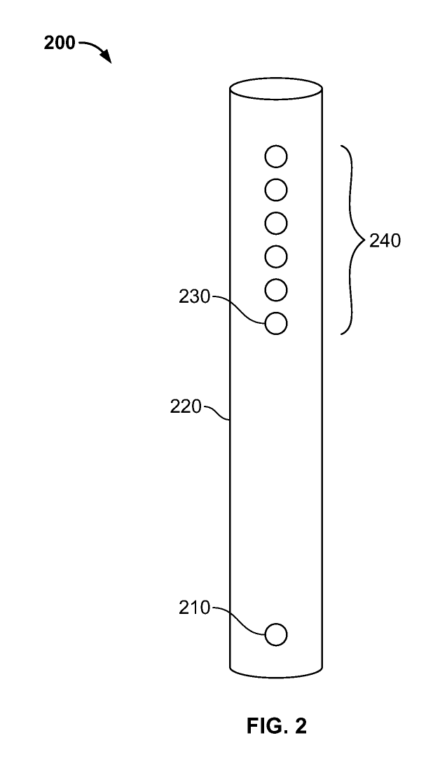

FIG. 2 shows a schematic of an acoustic tool 200 for use with BHA 90. Acoustic tool 200 may include one or more acoustic transducers 210 configured to transmit acoustic signals and disposed on a housing 220. The housing 220 may be part of drill string 20. Acoustic tool 200 may include one or more acoustic transducers 230 configured to receive acoustic signals and disposed on housing 220. In multiple sensor embodiments, the acoustic transducers 230 may be arranged in a sensor array 240. In some embodiments, acoustic transducer 210 may also be configured to receive. In some embodiments, acoustic transducer 230 may also be configured to transmit.

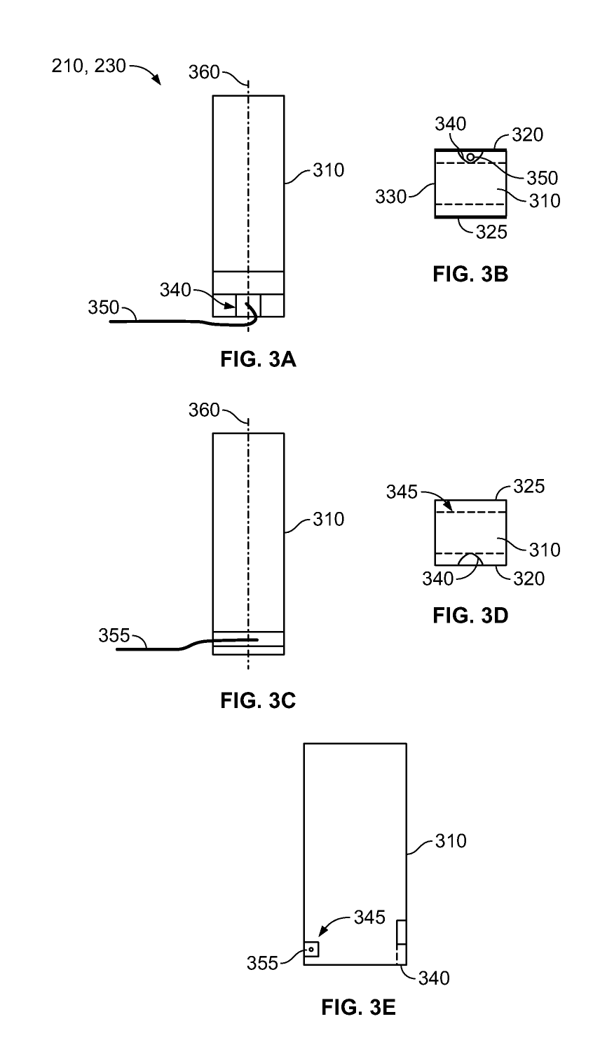

FIGS. 3A-3E show schematics of one embodiment of the acoustic transducer 210, 230 configured for use in borehole 26. FIG. 3A is a top view of acoustic transducer 210, 230. Acoustic transducer 210, 230 may include a piezoelectric component 310 with a first electrode 320 and a second electrode 325 disposed on the opposite sides of piezoelectric component 310. The piezoelectric component 310, first electrode 320, and second electrode 325 may be at least partly coated with an electrically conductive coating 330. The electrically conductive coating may include, but is not limited to, at least one of: (i) an electrode coating, (ii) a conductive epoxy, and (iii) a soldering material. Piezoelectric component 310 may include, but is not limited to, one or more of: (i) a piezocrystal, (ii) a piezoceramic, (iii) a piezocomposite, and (iv) a piezopolymer. FIG. 3B is a side view of acoustic transducer 210, 230. Piezoelectric component 310 may include a cavity 340 (such as a groove or notch) in piezoelectric component 310 over which first electrode 320 may be disposed. In one non-limiting embodiment, the cavity 340 may be rectangular in shape and oriented parallel with a long axis 360 of the piezoelectric material 310. The cavity 340 may be configured to receive a first conductor 350 configured to communicate power to the first electrode 320. FIG. 3C shows a bottom view of piezoelectric material 310 with a second cavity 345. In this non-limiting embodiment, second cavity 345 may be rectangular in shape and oriented perpendicular to the long axis 360. Second cavity 345 may be dimensioned to receive a conductor 355 configured to communicate power to the second electrode 325. FIG. 3D is another side view of transducer 210, 230. FIG. 3E is a right side view of transducer 210, 230. Using piezoelectric component 310 with cavities 340, 345 to form an acoustic transducer 210, 230 is exemplary and illustrative only, as this configuration may be used with other types of transducers known to those of skill in the art. The configuration of the acoustic transducer 210, 230 illustrates a non-limiting embodiment for use within a borehole, however, other embodiments may be configured for surface use, including, but not limited to, medical imagining non-destructive testing, etc.

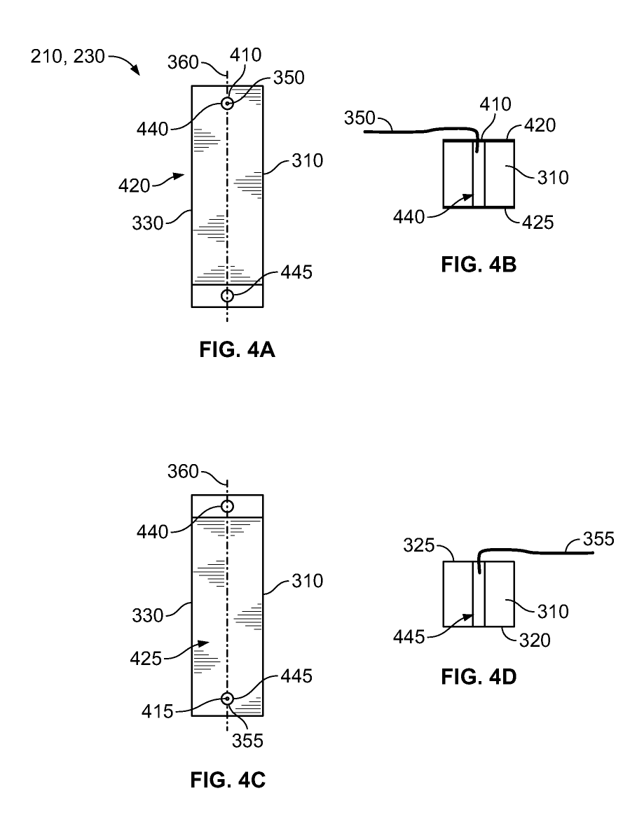

FIGS. 4A-D show schematics of another embodiment of the acoustic transducer 210, 230 configured for use in borehole 26. FIG. 4A is a top view of acoustic transducer 210, 230. Acoustic transducer 210, 230 may include a piezoelectric component 310 with a first electrode 420 and a second electrode 425 disposed on the opposite sides of piezoelectric component 310. The piezoelectric component 310, first electrode 420, and second electrode 425 may be at least partly coated with a conductive coating 330. Piezoelectric component 310 may include, but is not limited to, one or more of: (i) a piezocrystal and (ii) a piezoceramic. The first electrode 420 may have an opening 470 that is aligned with cavity 440 (such as a channel or passageway) in piezoelectric component 310. FIG. 4B is a side view of acoustic transducer 210, 230. At least part of the interior surface of cavity 440 may be coated with coating 330. In one non-limiting embodiment, the cavity 440 may be disposed on one end of piezoelectric component 310. The cavity 440 may be configured to receive a first conductor 350 configured to communicate power to the first electrode 320. FIG. 4C shows a bottom view of piezoelectric material 310 with a second cavity 445. In this non-limiting embodiment, second cavity 445 may be a channel though piezoelectric component 310 disposed on the opposite side from the first cavity 440. The second electrode 425 may have an opening 470 that is aligned with second cavity 445. Second cavity 445 may be dimensioned to receive a conductor 355 configured to communicate power to the second electrode 425. At least part of the interior surface of cavity 445 may be coated with coating 330. FIG. 4D is another side view of transducer 210, 230. Using piezoelectric component 310 with cavities 440 and 445 to form an acoustic transducer 210, 230 is exemplary and illustrative only, as this configuration may be used with other types of transducers known to those of skill in the art. The configuration of the acoustic transducer 210, 230 illustrates an non-limiting embodiment for use within a borehole, however, other embodiments may be configured for surface use, including, but not limited to, medical imagining non-destructive testing, etc.

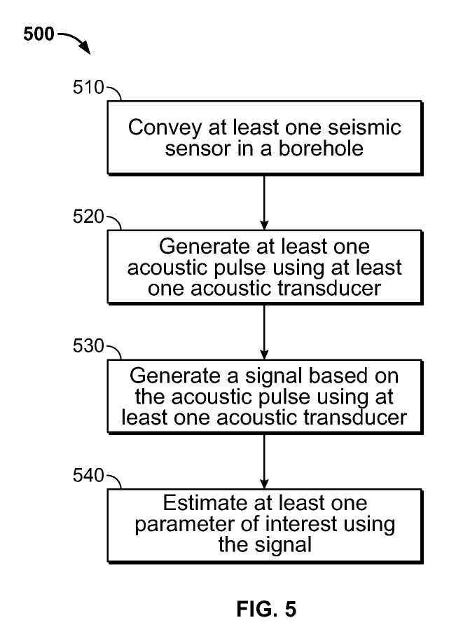

FIG. 5 shows a flow chart illustrating a method 500 according to one embodiment of the present disclosure. In step 510, acoustic tool 200 including at least one acoustic transducer 210 and at least one acoustic transducer 230 may be conveyed in the borehole 26. In step 520, an acoustic pulse may be generated by the at least one acoustic transducer 210. In step 530, the at least one acoustic transducer 230 may generate a signal indicative of a response of the borehole 26 to the acoustic pulse. In some embodiments, the same transducer 210, 230 may be configured to generate an acoustic pulse and generate a signal in response to a received acoustic pulse. In step 540, at least one parameter of interest of the formation may be estimated using the signal.

As described herein, the method in accordance with the presently disclosed embodiment of the disclosure involves several computational steps. As would be apparent by persons of ordinary skill, these steps may be performed by computational means such as a computer, or may be performed manually by an analyst, or by some combination thereof. As an example, where the disclosed embodiment calls for selection of measured values having certain characteristics, it would be apparent to those of ordinary skill in the art that such comparison could be performed based upon a subjective assessment by an analyst or by computational assessment by a computer system properly programmed to perform such a function. To the extent that the present disclosure is implemented utilizing computer equipment to perform one or more functions, it is believed that programming computer equipment to perform these steps would be a matter of routine engineering to persons of ordinary skill in the art having the benefit of the present disclosure.

Implicit in the processing of the acquired data is the use of a computer program implemented on a suitable computational platform (dedicated or general purpose) and embodied in a suitable machine readable medium that enables the processor to perform the control and processing. The term “processor” as used in the present disclosure is intended to encompass such devices as microcontrollers, microprocessors, field-programmable gate arrays (FPGAs) and the storage medium may include ROM, RAM, EPROM, EAROM, solid-state disk, optical media, magnetic media and other media and/or storage mechanisms as may be deemed appropriate. These are all examples of non-transitory computer readable media. As discussed above, processing and control functions may be performed downhole, at the surface, or in both locations.

Although a specific embodiment of the disclosure as well as possible variants and alternatives thereof have been described and/or suggested herein, it is to be understood that the present disclosure is intended to teach, suggest, and illustrate various features and aspects of the disclosure, but is not intended to be limiting with respect to the scope of the disclosure, as defined exclusively in and by the claims, which follow.

While the foregoing disclosure is directed to the specific embodiments of the disclosure, various modifications will be apparent to those skilled in the art. It is intended that all such variations within the scope of the appended claims be embraced by the foregoing disclosure.

What is claimed is:

1. A method of measuring a property of a material, comprising:
measuring the property of the material using a transducer, the transducer comprising:
a first electrical conductor,
a second electrical conductor, and
a piezoelectric component configured to receive the first electrical conductor in a first cavity and the second electrical conductor in a second cavity.

2. The method of claim 1, wherein the transducer further comprises:
a conductive coating configured to affix the piezoelectric component to at least one of: the first electrical conductor and the second electrical conductor.

3. The method of claim 2, wherein the conductive coating includes at least one of: (i) an electrode coating, (ii) a conductive epoxy, and (iii) a soldering material.

4. The method of claim 1, wherein the piezoelectric component includes at least one of: (i) a piezoceramic, (ii) a piezocrystal, (iii) a piezocomposite, and (iv) a piezopolymer.

5. The method of claim 1, wherein each of the first cavity and the second cavity includes at least one of: (i) a groove and (ii) a passageway.

6. The method of claim 1, further comprising:
conveying the transducer in a borehole penetrating the material, wherein the material is an earth formation.

7. An apparatus for measuring a property of a material, comprising:
a first electrical conductor;
a second electrical conductor; and
a piezoelectric component configured to receive the first electrical conductor in a first cavity and the second electrical conductor in a second cavity.

8. The apparatus of claim 7, further comprising:
a conductive coating configured to affix the piezoelectric component to at least one of: the first electrical conductor and the second electrical conductor.

9. The apparatus of claim 8, wherein the conductive coating includes at least one of: (i) an electrode coating, (ii) a conductive epoxy, and (iii) a soldering material.

10. The apparatus of claim 7, wherein the piezoelectric component includes at least one of: (i) a piezoceramic, (ii) a piezocrystal, (iii) a piezocomposite, and (iv) a piezopolymer.

11. The apparatus of claim 7, wherein each of the first cavity and the second cavity includes at least one of: (i) a groove and (ii) a passageway.

12. The apparatus of claim 7, wherein the piezoelectric component is configured for use in a borehole penetrating the material and the material is an earth formation.
